(19) United States
(12) Patent Application Publication
(10) Pub. No.: US 2012/0091835 A1
(43) Pub. Date: Apr. 19, 2012

(54) Motor-Generator Cooling System of Hybrid-Automobile

(75) Inventors: Kyungha Kim, Yongin-si (KR); Min Sung Kim, Seoul (KR); Baekyu Kim, Suwon-si (KR); Jinsook Lee, Uijeongbu-si (KR); Sungik Bae, Suwon-si (KR); Yeonho Kim, Suwon-si (KR); Wan Soo Kim, Hwaseong-si (KR)

(73) Assignee: HYUNDAI MOTOR COMPANY, Seoul (KR)

(21) Appl. No.: 12/951,383

(22) Filed: Nov. 22, 2010

(30) Foreign Application Priority Data
Oct. 13, 2010 (KR) 10-2010-0099989

(51) Int. Cl. H02K 9/19

(52) U.S. Cl. 310/54

(57) ABSTRACT

A motor/generator cooling system of a hybrid vehicle that has a first and second motor/generator disposed in an axial direction in a transmission, may include a cooling pipe that may be disposed in an axial direction along an upper and outside of the first and second motor/generator in the transmission, a rear cover that may be connected to a downstream side of the cooling pipe such that the cooling pipe may be fixed thereto, an input supporter that may be connected to an upstream side of the cooling pipe, forms a cooling oil passage, and rotatably supports a rotor of the first motor/generator, and a case that the rear cover and the input supporter may be mounted thereon, an oil filter connected to a hydraulic pump may be mounted therein, a penetration hole may be formed therein, and the cooling pipe penetrates the penetration hole to be fixed thereto.

### CROSS-REFERENCE TO RELATED APPLICATION

The present application claims priority to Korean Patent Application No. 10-2010-0099989 filed in the Korean Intellectual Property Office on Oct. 13, 2010, the entire contents of which is incorporated herein for all purposes by this reference.

### BACKGROUND OF THE INVENTION

1. Field of the Invention

The present invention relates to a motor/generator cooling system of a hybrid vehicle. More particularly, the present invention relates to a system that a hole is formed at a cooling pipe to inject cooling oil from an upper end of a transmission.

2. Description of Related Art

Generally, a hybrid vehicle effectively uses different kinds of power sources and the hybrid vehicle system includes an engine using a fuel and a motor using electric to output power.

The electric motor assists a power to accelerate the hybrid vehicle and the engine performs an optimized driving through an automatic transmission and when it is compared with a conventional vehicle provided with gasoline engine and an automatic transmission, the hybrid vehicle can reduce excellent fuel consumption.

The hybrid vehicle includes an engine and a transmission having a generator that is to be used to generate electricity and to start the engine.

The transmission uses a drive motor to move the vehicle at an early stage of the driving, because efficiency of the drive motor is excellent at a low RPM of the early stage of the driving.

And, at a speed higher than a predetermined value, the generator starts the engine and the engine and the drive motor simultaneously drives the wheel.

The hybrid vehicle operates an EV mode (Electric vehicle mode) as an electric power of the motor at a low speed and transfers the EV mode to a HEV mode {Hybrid Electric Vehicle Mode (motor+engine)} through an engine clutch at a speed higher than a predetermined value.

A general transmission that is applied to the hybrid vehicle as above will be described below, the transmission includes a motor and a transmission case that a motor is built in, and a transmission hydraulic pump is disposed to supply lubrication oil to constituent elements of the transmission inside the transmission case.

The transmission hydraulic pump is disposed in the transmission case to be connected to an oil filter.

During the operation of the motor of the hybrid vehicle, current is supplied to a stator coil 80, a heat is generated in the stator coil 80 proportional to the square of the current, and the generated heat is transferred to a stator 60 that is disposed at one side of the stator coil 80.

The stator 60 is made up of magnetic steel, the heat is transferred from the stator coil 80 to be over heated by a long time operation of the motor, and the operation efficiency of the motor is deteriorated thereby.

So as to resolve the above problem, a gear churns up oil to cool the motor according to a conventional art.

That is, as shown in FIG. 1, cooling oil is filled at a lower portion of the transmission 1 to the oil upper end line 50, the cooling oil is transferred to a transfer driven gear 20 by a rotation of a differential gear 30, then the oil is stored in an oil catch tank 10 to run down to the motor/generator cooling them.

As shown in FIG. 2, the cooling oil flows to a side of the case 10 from the oil catch tank 10 and flows in a lower side of the case 90 to cool the rotor 70 that a magnet is inserted and the stator 60 facing the rotor 70.

However, the method as described above does not realize accurate oil amount demanded by the motor/generator but depends on the churning of the differential gear 30 such that the transmission efficiency is deteriorated, and since the oil churning amount is varied by a rotation speed of the gear, there is a drawback that a cooling efficiency cannot be controlled.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide a motor/generator cooling system of hybrid vehicle having advantages of supplying hydraulic pressure through a simple cooling pipe so as to cool the motor/generator.

In an aspect of the present invention, the motor/generator cooling system of a hybrid vehicle that has a first and second motor/generator disposed in an axial direction in a transmission, may include a cooling pipe that is disposed in an axial direction along an upper and outside of the first and second motor/generator in the transmission; a rear cover that is connected to a downstream side of the cooling pipe such that the cooling pipe is fixed thereto; an input supporter that is connected to an upstream side of the cooling pipe, forms a cooling oil passage, and rotatably supports a rotor of the first motor/generator; and a case that the rear cover and the input supporter are mounted thereon, an oil filter connected to a hydraulic pump is mounted therein, a penetration hole is formed therein, and the cooling pipe penetrates the penetration hole to be fixed thereto.

The motor/generator cooling system may further include a steel ball that is disposed at an upper side of the cooling oil passage to prevent cooling oil from being leaked.

The motor/generator cooling system may further include an ATF (Automatic Transmission Fluid) cooler that is connected to a lower end of the input supporter to cool cooling oil; a motor cooling valve that is connected to an upstream of the ATF cooler to control oil supply amount and hydraulic pressure supplied to the first and second motor/generators; and a line pressure valve that is connected to an upstream of the motor cooling valve to form the oil supply amount and the hydraulic pressure, wherein the line pressure valve is connected to the hydraulic pump.

A groove is formed on the rear cover and a distal end of the cooling pipe is inserted into the groove to be fixed to the rear cover.

A plurality of holes are formed at a predetermined position of the cooling pipe.

A middle portion of the case protrudes inwards of the case to form a case middle part and the case middle part rotatably supports a rotor of the second motor/generator, wherein a second bearing is interposed between a rotor of the second motor/generator and the case middle part and oil passage is formed between the case middle part and the rotor of the second motor/generator to lubricate the second bearing.

A first bearing is interposed between a rotor of the first motor/generator and the input supporter and oil passage is formed inside the input supporter to lubricate the first bearing.

A bracket is disposed at the penetration hole of the case to fix the cooling pipe.

The present invention as described above supplies cooling oil necessary for cooling the motor/generator with a simple pipe structure such that the efficiency of the transmission is improved.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a cross-sectional view of a conventional transmission of a hybrid vehicle.

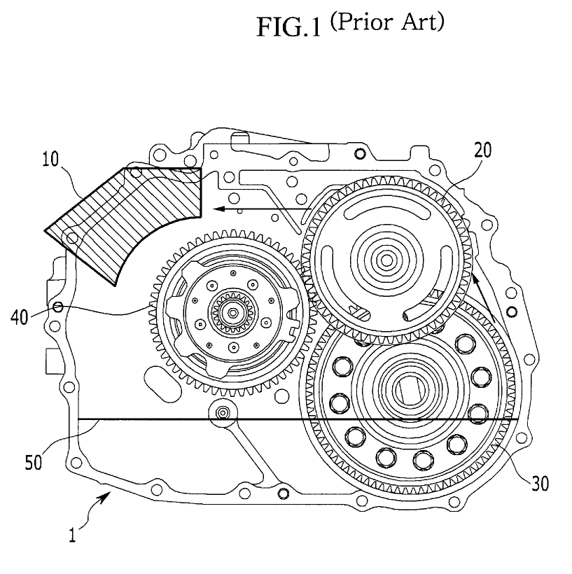

FIG. 2 is a cross-sectional view of a cooling system of a conventional motor of a hybrid vehicle.

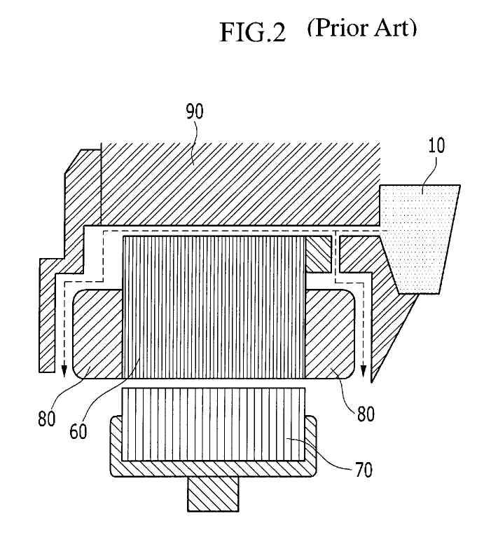

FIG. 3 is a partial sectional view and a schematic diagram of a motor/generator cooling system of a hybrid vehicle according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

In the following detailed description, only certain exemplary embodiments of the present invention have been shown and described, simply by way of illustration.

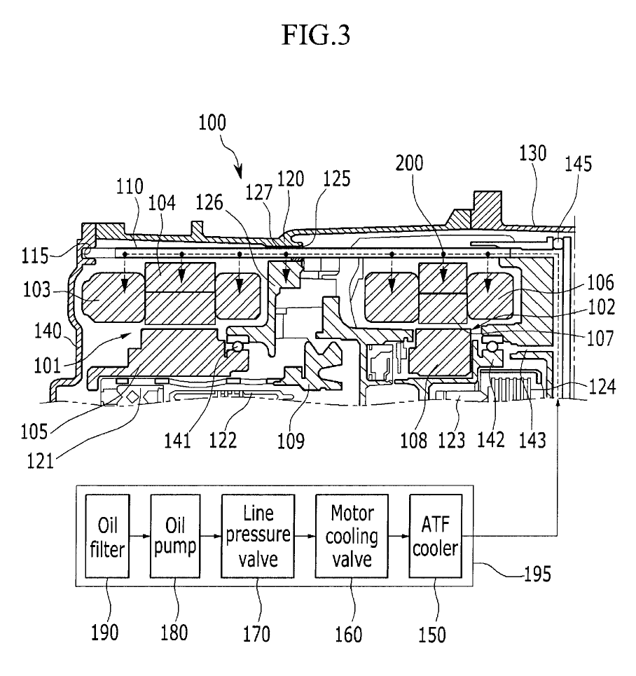

FIG. 3 is a partial sectional view and a schematic diagram of a motor/generator cooling system of a hybrid vehicle according to an exemplary embodiment of the present invention and shows main constituent elements of the transmission housing 100.

As shown in FIG. 3, a transmission housing 100 according to an exemplary embodiment of the present invention an input supporter 130 forming a cooling oil passage, a case 120 that is engaged with the input supporter 130 by a bolt and a first and second motor/generators 102 and 101, a first and second clutch assembly 124 and 122, a first and second planetary gear set 123 and 121 are built in, and a rear cover that is engaged with the case by a bolt and close/seals the transmission with the case 120.

Also, the case 120 includes a case middle part 126 that protrudes in the inside of the case. The case middle part 126 rotatably supports the second rotor.

And, a first and second motor/generators 102 and 101 according to the present invention is disposed inside the transmission housing 100 with a gap, a cooling pipe 110 is extended in an axial direction along the upper side of the first and second motor/generators 102 and 101, the first motor/generator 102 is disposed at an upstream side of the cooling oil, and the second motor/generator 101 is disposed at a downstream side of the cooling oil.

The first and second motor/generators 102 and 101 can be used as a motor and a generator and this can be used only a motor or can be used a motor and a generator.

The motor/generator can be variable controlled so as to realize maximum efficiency.

Also, a lower end of the first rotor 108 of the first motor/generator 102 is connected to a first planetary gear set 123 and a first clutch assembly 124 is disposed at one side of the first planetary gear set 123.

A lower end of a second rotor 105 of the second motor/generator 101 is connected to a second planetary gear set 121 and a second clutch assembly 122 is disposed at one side of the second planetary gear set 121.

And, a transfer drive gear 109 is disposed between the first and the second motor/generators 102 and 101.

The first and the second planetary gear set 123 and 121 are connected to each other and are able to shift gear according to a will of a driver.

And, an ATF cooler 150, a motor cooling valve 160, a line pressure valve 170, a hydraulic pump 180, and an oil filter 190 are disposed in transmission housing 100 according to an exemplary embodiment of the present invention.

A cooling pipe 110 is disposed to be extended in an axial direction at an outside of the motor/generators 102 and 101 so as to cool two motor/generators 102 and 101 that are disposed at a power delivery device according to an exemplary embodiment of the present invention.

The cooling pipe 110 has plurality of holes 200 at a predetermined point such that the cooling oil can be injected therethrough.

The position of the holes 200 can be varied depending on the position of the motor/generators 102 and 101 and can be formed in a position that a person of an ordinary skill in the art believes that it is to be cooled.

The input supporter 130 connected to an upstream side of the cooling pipe 110 to form an oil passage for supplying the cooling pipe 110 with cooling oil.

The input supporter 130 is connected to an ATF (Automatic Transmission Fluid) cooler 150 such that the ATF cooler 150 cools the oil supplied to the input supporter 130.

The case 120 is disposed at an outside of the cooling pipe to fix the cooling pipe 110 by a bolt and the rear cover 140 is disposed at a downstream of the cooling pipe 110 to support the cooling pipe 110 such that the cooling pipe 110 inserted therein is fixed.

In this case, a groove 115 is formed in the rear cover 140 and the cooling pipe 110 is inserted into the groove to be fixed.

Also, a motor cooling valve 160 is connected to the other end of the ATF cooler 150 that one side thereof is connected to the input supporter 130, the motor cooling valve 160 is connected to the line pressure valve 170, the line pressure valve 170 is connected to the hydraulic pump 180, and the hydraulic pump 180 is connected to the oil filter 190.

In this case, the oil filter 190 filters foreign materials when the hydraulic pump 180 draws in the cooling oil (AFT), the hydraulic pump 180 draws in the cooling oil and supplies the hydraulic pressure, the line pressure valve 170 forms a control pressure demanded from the oil that is supplied by the hydraulic pump 180, and the motor cooling valve 160 keeps the flowing amount and hydraulic pressure that is supplied to the first and second motor/generators 102 and 101 at a certain range and mainly supplies the cooling oil supplied from the line pressure valve 170.

Hereinafter, an exemplary embodiment according to the present invention will be described for the sake of flowing of the cooling oil.

In a process that the first and second motor/generators 102 and 101 are operating, if current is transmitted to the first and second stator coil 106 and 103, heat is formed around the first and second stator coil 106 and 103, and the heat is transferred to the first and second stator 107 and 104 and is transferred to the first and second rotor 108 and 105 facing with the first and second stator 107 and 104. The first and second motor/generators 102 and 101 are to be cooled so as to be normally operated.

ATF is filled at a lower space of the transmission housing 100, which is cooling oil of an automatic transmission.

While the oil is drawn into the hydraulic pump 180, the oil filter 190 filters foreign materials.

The hydraulic pressure is formed by the line pressure valve 170 to cool the first and second motor/generators 102 and 101, and the cooling oil that the foreign material is filtered passes the line pressure valve 170 to be supplied to the motor cooling valve 160 with a hydraulic pressure formed by the line pressure valve 170 through the motor cooling valve 160.

That is, the motor cooling valve 160 supplies the oil having the flux and hydraulic pressure formed by the line pressure valve 170 to the ATF cooler 150.

The cooling oil supplied to the ATF cooler 150 is cooled by the ATF cooler 150. The cooled oil is supplied to the input supporter 130 and the input supporter 130 offers a passage for the cooling oil.

The cooling oil passing the input supporter 130 passes the cooling pipe 110. In this moment, a plurality of holes 200 are formed in cooling pipe 110 and the cooling oil is injected through the holes 200. The injected cooling oil falls down to the outside of the first and second motor/generators 102 and 101 to cool the first and second motor/generators 102 and 101.

The cooling oil fallen down is filled at a lower end of the transmission housing 100 and the cooling oil repeats the above process.

In the process, the case 120 is disposed at an outside of the cooling pipe 110 in a length direction of the cooling pipe 110, the cooling pipe 110 is engaged with the bolt to be fixed in the case 120, a rear cover 140 is disposed at a downstream side of the cooling pipe 110 and a groove 115 is formed on the rear cover 140, and the cooling pipe 110 is inserted into the groove to be fixed thereto.

The first and second motor/generators 102 and 101 of the hybrid vehicle can be cooled through a simple structure as described above.

In an exemplary embodiment of the present invention, a penetration hole 127 may be formed in the case 120 and the cooling pipe 110 penetrates the penetration hole 127 to be fixed thereto.

A first bearing 142 may be interposed between a rotor 108 of the first motor/generator 102 and the input supporter 130 and oil passage is formed inside the input supporter 130 to lubricate the first bearing 142.

A second bearing 141 is interposed between a rotor 105 of the second motor/generator 101 and the case middle part 126 and oil passage is formed between the case middle part 126 and the rotor 105 of the second motor/generator 101 to lubricate the second bearing 141.

A steel ball 145 may be disposed at an upper side of a cooling oil passage in the cooling pipe 110 to prevent the cooling oil from being leaked.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A motor/generator cooling system of a hybrid vehicle that has a first and second motor/generator disposed in an axial direction in a transmission, comprising:
a cooling pipe that is disposed in an axial direction along an upper and outside of the first and second motor/generator in the transmission;
a rear cover that is connected to a downstream side of the cooling pipe such that the cooling pipe is fixed thereto;
an input supporter that is connected to an upstream side of the cooling pipe, forms a cooling oil passage, and rotatably supports a rotor of the first motor/generator; and
a case that the rear cover and the input supporter are mounted thereon, an oil filter connected to a hydraulic pump is mounted therein, a penetration hole is formed therein, and the cooling pipe penetrates the penetration hole to be fixed thereto.

2. The motor/generator cooling system of claim 1, further comprising a steel ball that is disposed at an upper side of the cooling oil passage to prevent cooling oil from being leaked.

3. The motor/generator cooling system of claim 1, further comprising:
an ATF (Automatic Transmission Fluid) cooler that is connected to a lower end of the input supporter to cool cooling oil;
a motor cooling valve that is connected to an upstream of the ATF cooler to control oil supply amount and hydraulic pressure supplied to the first and second motor/generators; and
a line pressure valve that is connected to an upstream of the motor cooling valve to form the oil supply amount and the hydraulic pressure, wherein the line pressure valve is connected to the hydraulic pump.

4. The motor/generator cooling system of claim 1, wherein a groove is formed on the rear cover and a distal end of the cooling pipe is inserted into the groove to be fixed to the rear cover.

5. The motor/generator cooling system of claim 1, wherein a plurality of holes are formed at a predetermined position of the cooling pipe.

6. The motor/generator cooling system of claim 1, wherein a middle portion of the case protrudes inwards of the case to form a case middle part and the case middle part rotatably supports a rotor of the second motor/generator.

7. The motor/generator cooling system of claim 6, wherein a second bearing is interposed between a rotor of the second motor/generator and the case middle part and oil passage is formed between the case middle part and the rotor of the second motor/generator to lubricate the second bearing.

8. The motor/generator cooling system of claim 1, wherein a first bearing is interposed between a rotor of the first motor/generator and the input supporter and oil passage is formed inside the input supporter to lubricate the first bearing.

9. The motor/generator cooling system of claim 1, wherein a bracket is disposed at the penetration hole of the case to fix the cooling pipe.
